(19) United States
(12) Patent Application Publication
(10) Pub. No.: US 2019/0173746 A1
(43) Pub. Date: Jun. 6, 2019

(54) Method of Creating Distributed Computer Processing Network

(71) Applicant: Adam Winter, Lynnwood, WA (US)

(72) Inventor: Adam Winter, Lynnwood, WA (US)

(21) Appl. No.: 15/832,720

(22) Filed: Dec. 5, 2017

(51) Int. Cl. H04L 12/24

(52) U.S. Cl. CPC H04L 41/0806; H04L 41/5061; H04L 41/20

(57) ABSTRACT

A method for creating a network of computational devices which are installed in computers. The computers are distributed to customers who are aware of the devices and consent to the arrangement. The computers are installed in the homes or places of business of the customers, thereby creating a distributed processing network which does not require any special dedicated space of its own nor any special means of providing electricity to it.

### CROSS REFERENCE TO RELATED APPLICATIONS

Not applicable.

### FEDERALLY SPONSORED R/D

Not applicable.

### REFERENCE TO APPENDIX

Not applicable.

### BACKGROUND

Many jobs that are given to computers can be split into many smaller parts, and each of these parts can be processed in parallel. Likewise, there is much work to be done by computers that is simply repetitions of smaller pieces of work, which can also be handled in parallel. Sometimes the magnitude of this computational work at hand would require an amount of space to house the computers, and an amount of electrical energy, so large that it may not be practical to place all of that hardware at one location. As a solution to this problem, a method is provided for distributing the physical hardware in such a way that no special space for the hardware is needed, and no special electrical infrastructure is required.

### BRIEF DESCRIPTION OF DRAWINGS

FIG. 1. Shows a network of n computers. Each computer in the network has an established connection with the server from which it retrieves work orders and reports the results of that work back to. The administrator's computer is also shown logged in to one or more of the computers for maintenance and to direct the computer to the desired server.

### DETAILED DESCRIPTION OF THE INVENTION

In this method, a buyer-seller relationship is utilized to distribute computers to customers as a means of distributing hardware that is installed in the computer. The business of selling the computers is strictly a means of creating a thing. That is, the distribution is just part of the method of creating the distributed network, and requires more than just selling computers. In the context of this method, the seller is the administrator of the network. Since the purpose of the arrangement between buyer and seller, for the administrator, is to distribute the processing hardware, actual purchase may not be necessary. That is, the buyer may actually receive the computer at no cost, or even be paid for their role in the arrangement. Nevertheless, for semantic purposes, we will refer to the two parties as the “administrator” and the “customer.”

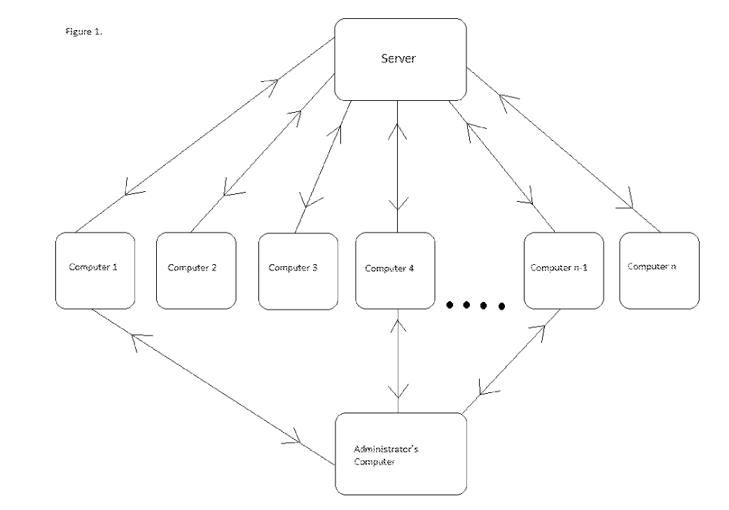

Hardware devices, with many parallel processing cores, are installed into standard desktop PCs or laptops. An example of such a device is a GPU (FIG. 1). The significance of the quantity of processing cores refers to the difference between the standard CPU that every computer must already have, and another device which a computer may or may not have, but in this case is installed specifically for the benefit of the administrator, not the customer. Standard CPUs are not known to have as many as 100 processing cores, while GPUs are known to have many thousands. That is, this method does not make the claim of creating a processing network by distributing CPUs (regular computers). Moreover, such a CPU would be used by the customer, not dedicated to the administrator's purposes. In this method, the device is dedicated to the distributed processing network, and not used by the customer. The devices are installed directly onto the computer motherboards through PCIe ports on the motherboards. No other devices or accessories are require for installation since the devices fit directly onto the existing PCIe ports on the motherboards.

Multiple instances of individual computers are distributed to customers. In one such instance, upon agreement between the administrator and the customer, the computer (containing the installed processing device) is installed within the customer's home. The computer is powered on, connected to the internet, and all necessary accessories are installed (keyboard, mouse, monitor, etc . . . ). The computer's operating system is programmed to have separate user accounts for the administrator and the customer. A person having ordinary skill in the art will appreciate that this can also be accomplished by having parallel instances of different operating systems active on the computer. The customer does not have access to make changes to any settings, running programs, or files that are accessed through the administrator's account. Furthermore, a person having ordinary skill in the art will appreciate that the computers could be installed in the customer's place of business, alternatively to the customer's home, or some combination thereof. Also, a person having ordinary skill in the art will appreciate that the person who physically installs the computer could also be an agent of the administrator, or the customers themselves. The distinguishing matter is the fact that the source of the computer obtained by the customer is the administrator, and provided by the administrator for the sake of creating the distributed processing network.

Within the administrators account, the administrator will launch software that controls the installed devices and gives it work to be done. The software also communicates with a remote server, over the internet, to retrieve what work is to be done, and reports the results of that work back to said server. A person having ordinary skill in the art will appreciate that this server may be administered by the same administrator, and may be administered by a third party. At any given time that the device is doing its work, at the same time, the customer is able to use the other components of the computer, as a person would typically use a computer, with minimal impact by the administrator's processes. That is the vast majority of the resources required to do the administrator's work are within the device, and the shared resources (shared between the administrator and the customer) are only used by the administrator an amount that is negligible to the customer. A person having ordinary skill in the art will appreciate that additional software may be run on the computer that allows the administrator to remotely manage the computer over the internet.

The novelty of this method lies in the fact that there is a device installed in the customer's computer, with the customer's expressed approval, that is not there for the use of the customer. Putting hardware in a computer and selling it to someone may seem trivial. However, the additional electrical energy costs to the customer can be substantial, and that would not be a trivial matter to the customer. Furthermore, the aggregate processing power, when all of these devices are working together, could make it one of the largest super-computers every created; a novelty indeed. While any methods in existence would only create something that has already been created. It is important to note that this entire process is done with the full intention that anyone who receives one of these computers is fully aware that there is hardware in the machine that is extraneous to their own purposes for having the computer and that that hardware is there to do work for the party from which they received the computer. This is not an idea for sneaking rouge devices into people's computers.

### PRIOR ART

Many distributed computer processing networks have been created by maliciously installing software into a person's existing computer, or by convincing people to willingly install software on their existing computers. Besides consent, the difference is that the owner of the computer did not receive the computer from the administrator of that processing network. That is, that administrator did not create the network by distributing the hardware. No prior art exists in which a distributed processing network is created by distributing computers that contain hardware dedicated to that processing network to customers' homes and businesses.

Other patents pertaining to distributed processing seek to patent their version of the network itself, rather than the method by which it is physically deployed (U.S. Pat. Nos. 8,553,139, 9,017,398, 7,743,390, 8,263,954) (none of which are deployed to homes/businesses anyways), or claim a network with a centralized processor serving distributed workstations (U.S. Pat. No. 9,017,398), or claim a protocol used for data transfer (see U.S. Pat. No. 7,743,390), or claim a method for software to use in processing (U.S. Pat. No. 12,543,476). Otherwise, the claims are in reference to a parallel processing machines in which the individual processors are in close physical proximity to each other (in the same building), or connected over a local area network, rather than the internet (U.S. Pat. No. 8,480,691). U.S. Pat. No. 9,124,435 does speak to the matter of a task being processed by a client, however the term “distribute” (“distributed” or “distribution”) are used exclusively in reference to how much of a task is processed by the server and how much of it is processed by the client, as that is the matter that it seeks to resolve; which is a very different thing as the tasks at hand in this application are simply not being considered for processing on the server side.

1. A method of creating a distributed computer processing network, comprised of repetitions of the following:
Connection of a computational hardware device to the motherboard of a computer
said connection is to the PCIe port on said motherboard
said device has greater than 100 parallel processing cores.
Programming of the operating system on said computer to have separate user accounts for the administrator and the customer
Installation of said computer in a customer's home, by an administrator
said hardware is not utilized by the customer for any of the customer's own purposes
other hardware in said computer is used by customer as customer's personal computer.
Launching of software on said computer through administrator's user account
said computer contains software used to control said hardware
said software is not accessed or used by the customer.
Connection between said computer and dedicated remote server is established over the internet
said software retrieves work orders to be done by said hardware from associated server over the internet
said software also reports results of said work to said server
said server is dedicated to giving work to the device and accepting results from the work
said administrator is also the administrator of said server.
